(19) United States
(12) Patent Application Publication
(10) Pub. No.: US 2009/0316573 A1
(43) Pub. Date: Dec. 24, 2009

(54) SYSTEM AND METHOD FOR TRANSMITTING MESSAGES USING A REDUNDANCY MECHANISM

(75) Inventor: Chien-Pan Lai, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/417,647

(22) Filed: Apr. 3, 2009

(30) Foreign Application Priority Data
Jun. 18, 2008 (CN) 200810302190.7

(51) Int. Cl. G06F 11/00

(52) U.S. Cl. 370/221

(57) ABSTRACT

A system for transmitting messages using a redundancy mechanism includes an active main processing unit (MPU) and a standby MPU. The active MPU is used to receive a request message sent from an end-user device and send the request message to a router connected with the active MPU. When the active MPU cannot work normally, the standby MPU is activated as a new active MPU. The new active MPU transmits the request message instead of the active MPU.

### BACKGROUND

1. Technical Field

Embodiments of the present disclosure relate to communication systems and methods, and more particularly to a system and method for transmitting messages using a redundancy mechanism.

2. Description of Related Art

Multicast is a receiver-based concept that allows receivers to join a particular multicast group by sending request messages to a corresponding multicast router, where traffic is delivered to all members in the group by the network infrastructure. Membership of a multicast group is dynamic. That is, clients may join and leave any group at any time via the Internet group message protocol (IGMP).

In a dynamic access mode, a client has to send an IGMP message to request a server to join a multicast group via a main processing unit (MPU). If the MPU is not working normally, the message cannot be transmitted to the server successfully.

Therefore, an effective system and method for transmitting messages is desired to overcome the above-described shortcomings.

### BRIEF DESCRIPTION OF THE DRAWINGS

FIG. 1 is a block diagram of one embodiment of a system for transmitting messages using a redundancy mechanism.

FIGS. 2A-2B are a flowchart of one embodiment of a method for transmitting messages using a redundancy mechanism.

### DETAILED DESCRIPTION

The components in the drawings are not necessarily drawn to scale, the emphasis instead being placed upon clearly illustrating the principles of at least one embodiment. In the drawings, like reference numerals designate corresponding parts throughout the various views.

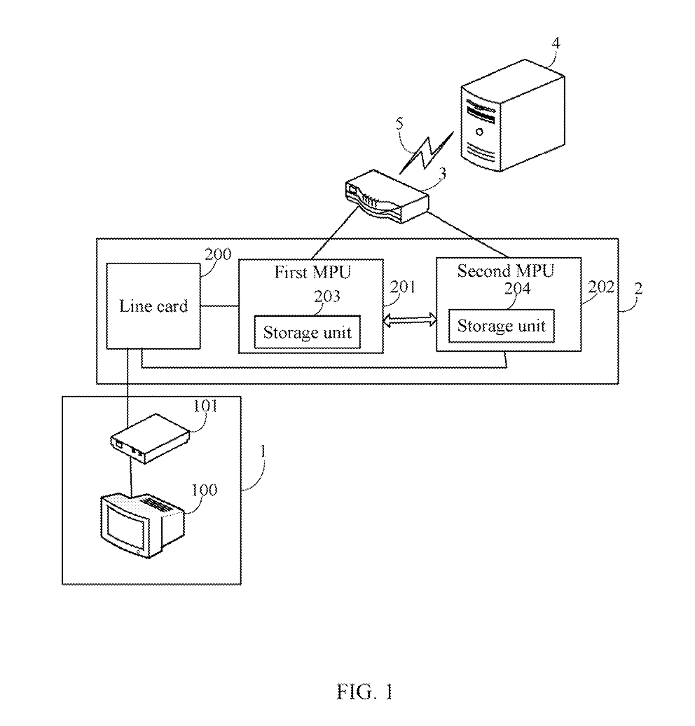

FIG. 1 is a block diagram of one embodiment of a system 2 for transmitting messages using a redundancy mechanism. In one embodiment, the system 2 may include a line card 200, a first main processing unit (MPU) 201, and a second MPU 202. In one embodiment, the line card 200 may be an Asymmetric Digital Subscriber Line (ADSL) line card.

The system 2 connects with an end-user device 1 via the line card 200. The end-user device 1 may include a television (TV) 100 and a set-top box 101. The set-top box 101 may send a request message to the line card 200 according to a user's requirement. The request message may be an Internet group message protocol (IGMP) join message or an IGMP leave message. The IGMP join message is a request for joining the end-user device 1 to a multicast group, and the IGMP leave message is a request to leave a multicast group. For example, when a user of the end-user device 1 selects a TV channel using an input device (e.g., a remote device) (not shown in FIG. 1), the input device sends an instruction to the set-top box 101, and then the set-top box 101 sends an IGMP join message to the line card 200. When the user selects another TV channel using the input device, the input device sends an instruction to the set-top box 101, and then the set-top box 101 sends an IGMP leave message to the line card 200.

The line card 200 is connected with the first MPU 201 and the second MPU 202. The first MPU 201 includes a storage unit 203 for storing the IGMP join messages received by the first MPU 201. After storing the IGMP join messages, the first MPU 201 sends the IGMP join messages to the second MPU 202. The second MPU 202 includes a storage unit 204 for storing the IGMP join messages sent from the first MPU 201.

The first MPU 201 and the second MPU 202 are connected to a router 3. The router 3 connects with a server 4 via a network 5. In one embodiment, the network 5 may be the Internet or an intranet.

At any time, only one MPU (e.g., the first MPU 201) is in an active state, and another MPU (e.g., the second MPU 202) is in a standby state. The active MPU transmits messages between the line card 200 and the router 3. The active MPU sends state packets including the state of the active MPU to the standby MPU at regular intervals. If the active MPU malfunctions, the standby MPU cannot receive the state packets from the active MPU so the standby MPU is activated as a new active MPU, and the active MPU goes into a standby state. In one embodiment, the first MPU 201 defaults as the active MPU and the second MPU 202 defaults as the standby MPU. When the first MPU 201 malfunctions, the second MPU 202 cannot receive the state packets and is activated as the new active MPU. Afterwards, the first MPU 201 becomes a new standby MPU.

When working as the active MPU, the first MPU 201 receives the IGMP join message sent from the line card 200 and stores the IGMP join message into the storage unit 203. Simultaneously, the first MPU 201 copies the IGMP join message and sends the copied message to the second MPU 202. The second MPU 202 stores the copied message into the storage unit 204. If the first MPU 201 malfunctions, the second MPU 202 is activated as the new active MPU and sends the IGMP join message stored in the storage unit 204 to the router 3. Simultaneously, the second MPU 202 sends an IGMP query message to the line card 200 for querying the end-user device 1 to resend a new IGMP join message. In one embodiment, the line card 200 sends the IGMP query message to the set-top box 101. The set-top box 101 sends a new IGMP join message to the second MPU 202 via the line card 200. The second MPU 202 detects if the new IGMP join message is the same as the IGMP join message stored in the storage unit 204. If the new IGMP join message is different from the IGMP join message stored in the storage unit 204, the second MPU 202 updates the IGMP join message stored in the storage unit 204 with the new IGMP join message and sends the new IGMP join message to the router 3. The router 3 sends the new IGMP join message to the server 4 via the network 5. The server 4 joins the end-user device 1 to the multicast group.

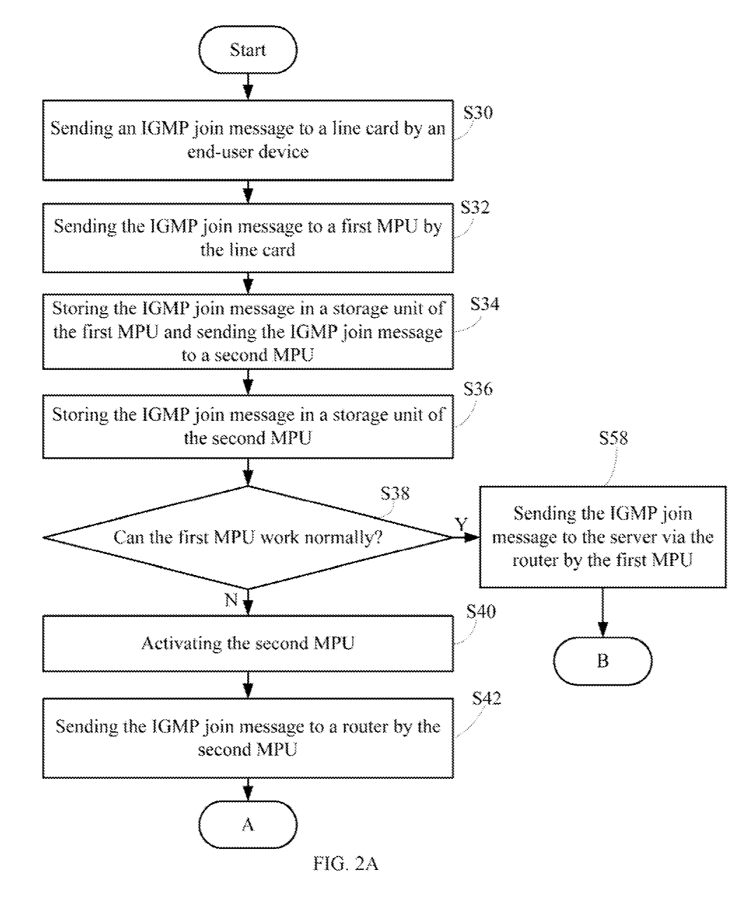

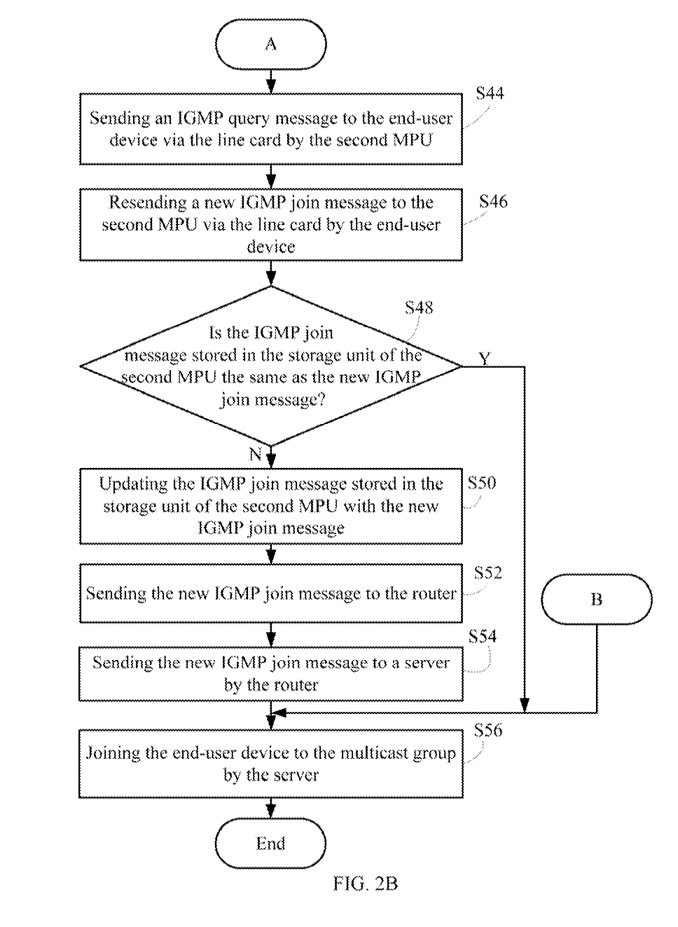

FIG. 2 is a flowchart of one embodiment of a method for transmitting messages using a redundancy mechanism. Depending on the embodiment, additional blocks may be added, others removed, and the ordering of the blocks may be changed. In one embodiment, at the beginning, the first MPU 201 is the active MPU, and the second MPU 202 is the standby MPU.

In block S30, a user may send a channel selecting instruction using an input device of the end-user device. Accordingly, the end-user device 1 sends an IGMP join message to the line card 200 for joining a multicast group. As mentioned above, the end-user device 1 includes the TV 100 and the set-top box 101. The IGMP join message may include an IP address of the multicast group.

In block S32, the line card 200 sends the IGMP join message to the first MPU 201.

In block S34, the first MPU 201 stores the IGMP join message into the storage unit 203, copies the IGMP join message and sends the copied IGMP join message to the second MPU 202.

In block S36, the second MPU 202 stores the copied IGMP join message into the storage unit 204.

In block S38, the second MPU 202 detects if the first MPU 201 works normally. If the first MPU 201 works normally, the procedure comes to block S58, the first MPU 201 directly sends the IGMP join message stored in the storage unit 204 to the router 3, and the router 3 sends the IGMP join message to the server 4. The procedure comes to the block S56.

If the first MPU 201 cannot work normally, in block S40, the second MPU 202 is activated as a new active MPU, and the first MPU 201 goes into a standby state. For example, the first MPU 201 may malfunction if the first MPU 201 is removed or upgraded. The second MPU 202 cannot receive state packets including the state of the first MPU 201. Therefore the second MPU 202 is activated as a new active MPU.

In block S42, the second MPU 202 sends the IGMP join message stored in the storage unit 204 to the router 3, the router 3 sends the IGMP join message to the server 4.

In block S44, the second MPU 202 sends an IGMP query message to the line card 200. The line card 200 sends the IGMP query message to the end-user device 1 after receiving the IGMP query message from the second MPU 202.

In block S46, the end-user device 1 resends a new IGMP join message to the second MPU 202 via the line card 200 after receiving the IGMP query message.

In block S48, the second MPU 202 detects if the received new IGMP join message is the same as the IGMP join message stored in the storage unit 204. If the new IGMP join message is the same as the IGMP join message stored in the storage unit 204, the procedure ends.

If the new IGMP join message is different from the IGMP join message stored in the storage unit 204, in block S50, the second MPU 202 updates the IGMP join message stored in the storage unit 204 with the new IGMP join message.

In block S52, the second MPU 202 sends the new IGMP join message to the router 3.

In block S54, the router 3 transmits the IGMP join message to the server 4 via the network 5.

In block S56, the server 4 joins the end-user device 1 to the multicast group.

As described in the above embodiments, the present disclosure uses a redundancy mechanism to transmit messages. That is, there are two MPUs including an active MPU and a standby MPU. The active MPU is used to transmit messages. When the active MPU cannot work normally, the standby MPU is activated as a new active MPU. The new active MPU transmits the request message instead of the active MPU. Using the present disclosure, the transmission of the messages will not be interrupted by fault of the active MPU.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for transmitting messages using a redundancy mechanism, the system comprising:
an active main processing unit (MPU) configured for receiving a request message from a line card connected with the active MPU, for storing the request message into a storage unit of the active MPU, and sending the request message to a router and a standby MPU connected to the active MPU;
the standby MPU configured for receiving the request message sent from the active MPU and storing the request message into a storage unit of the standby MPU;
the standby MPU being activated as a new active MPU if the active MPU cannot work normally, the standby MPU further configured for sending the request message stored in the storage unit of the new active MPU to the router and sending a query message to the line card; and
the new active MPU configured for updating the request message stored in the storage unit of the new active MPU with a new request message sent from the line card if the new request message is different from the request message stored in the storage unit of the new active MPU, and for sending the new request message to the router.

2. The system of claim 1, wherein the request message and the new request message are requests for joining an end-user device to a multicast group.

3. The system of claim 2, wherein the request message and the new request message are sent from the end-user device.

4. The system of claim 2, wherein the end-user device is a television and a set-top box.

5. The system of claim 2, wherein the router connects with a server, the server configured for receiving the request message and the new request message sent from the router, and for joining the end-user device to the multicast group.

6. A method for transmitting messages using a redundancy mechanism, the method comprising:
receiving a request message from a line card by an active Main processing unit (MPU);
storing the request message into a storage unit of the active MPU, sending the request message to a router connected to the active MPU, and sending the request message to a standby MPU;
storing the request message into a storage unit of the standby MPU;
activate the standby MPU as a new active MPU if the active MPU cannot work normally;
sending the request message stored in the storage unit of the new active MPU to the router and sending a query message to the line card;
updating the request message in the storage unit of the new active MPU with a new request message sent from the line card, if the new request message is different from the request message stored in the storage unit of the new active MPU; and
sending the new request message to the router by the new active MPU.

7. The method of claim 6, wherein the request message and the new request message are requests for joining an end-user device to a multicast group.

8. The method of claim 7, wherein the request message and the new request message are sent from the end user device.

9. The method of claim 7, wherein the end-user device is a television and a set-top box.

10. The method of claim 7, further comprising: receiving the request message and the new request message sent from the router by a server connected with the router, and joining the end-user device to the multicast group.
